(19) United States
(12) Patent Application Publication
(10) Pub. No.: US 2021/0013786 A1
(43) Pub. Date: Jan. 14, 2021

(54) HIGH FREQUENCY RESONANT LINEAR MACHINES

(71) Applicant: West Virginia University, Morgantown, WV (US)

(72) Inventors: Parviz Famouri, Morgantown, WV (US); Nigel Clark, Morgantown, WV (US)

(21) Appl. No.: 16/918,394

(22) Filed: Jul. 1, 2020

Related U.S. Application Data
(60) Provisional application No. 62/871,597, filed on Jul. 8, 2019.

(51) Int. Cl. H02K 33/18; H02K 33/02

(52) U.S. Cl. CPC H02K 33/18; H02K 33/02

(57) ABSTRACT

Various examples are provided related to linear resonant machines. In one example, a linear resonant machine includes an electrical stator including a winding; a translator disposed within the winding; and one or more springs that can provide axial coupling force. The one or more springs can include a flexure plate coupled between the translator and a chassis or the stator assembly of the linear resonant machine. The flexure plates can oscillate the translator axially at a resonant frequency within the at least one winding of the electrical stator. One or more engines can be coupled to a shaft of the translator to operate the linear resonant machine as a generator. The winding of the electrical stator can be excited to operate the linear resonant machine as a motor.

### CROSS REFERENCE TO RELATED APPLICATIONS

This application claims priority to, and the benefit of, co-pending U.S. provisional application entitled “High Frequency Resonant Linear Machines” having Ser. No. 62/871,597, filed Jul. 8, 2019, which is hereby incorporated by reference in its entirety.

### STATEMENT REGARDING FEDERALLY SPONSORED RESEARCH OR DEVELOPMENT

This invention was made with government support under contract DE-AR0000608 awarded by the U.S. Department of Energy. The Government has certain rights in the invention.

### BACKGROUND

Energy utilization and emissions from fossil-fueled combustion have been at the forefront of engine design since the 1960's due to the Clean Air Act, subsequent amendments, and regulations. Electrical power generation from fossil-based fuels in the United States (US), and elsewhere, are characterized as boiler-based Rankine cycle, gas turbine-based Brayton cycle, or reciprocating internal combustion engine-based Otto or Diesel cycles. Other cycles exist but have not seen wide scale commercialization. Fuels have historically been coal for the Rankine cycle, natural gas for the Brayton cycle, fuel oil for the Diesel cycle, and natural gas or gasoline for the Otto cycle. With the economic recovery of natural gas from shale and the significant long-term availability, the US has shifted the concept of distributed power generation to a local power generation at the end user. The US Department of Energy (DOE) identified that the efficient home of the future will require approximately 1 kW of power to operate the electrical demand throughout the day.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a cross-sectional view of an example of a linear resonant machine, in accordance with various embodiments of the present disclosure.

FIG. 2 is an example of a flexure spring, in accordance with various embodiments of the present disclosure.

FIG. 3 is a cross-sectional perspective view illustrating an example of a linear resonant machine (alternator), in accordance with various embodiments of the present disclosure.

FIGS. 4A-4F are images of a fabricated linear resonant machine, in accordance with various embodiments of the present disclosure.

FIG. 5 is an image of a setup for testing the linear resonant machine, in accordance with various embodiments of the present disclosure.

FIGS. 6A-6F are plots illustrating test data from the linear resonant machine, in accordance with various embodiments of the present disclosure.

### DETAILED DESCRIPTION

Disclosed herein are various examples related to high frequency resonant linear machines, characterized by a translator assembly that moves cyclically through a substantially linear stroke relative to a stator assembly. Broadly, there exists a need to develop integrated linear motion systems that employ resonance, including a linear motor/generator for many applications and an integrated engine and electrical generator with self-starting capability. Such devices can employ the resonance to promote high power density, high efficiency, long life, low cost, low variance in performance between cycles and the ability to minimize stalling under transient load. Reference will now be made in detail to the description of the embodiments as illustrated in the drawings, wherein like reference numbers indicate like parts throughout the several views.

A high frequency resonant linear motion electric motor/generator, which can be integrated with a high frequency resonant engine to yield a system to produce electricity or drive a translational load, has been developed for a broad range of applications. The stand-alone electric motor/generator (and the combined engine and electric generator) can be designed to have low losses and a low number of moving parts. The technology incorporates springs that serve to increase the system oscillating frequency and electric power density. The springs serve to store energy at the two extremes of the stroke of the system and support a high degree of cycle-to-cycle stability. Energy moves back and forth between kinetic energy of the linearly moving parts and the stored energy of the springs over the system stroke. Although a wide variety of mechanical or gas compression springs may be employed, flexure springs are preferred because they can also serve as linear bearings to react radial forces in the system. The flexure springs employed in a resonant system offer a degree of freedom by offering modest restraint to axial motion, while providing substantial restraint to movement in a radial direction. The flexure springs may also be assisted in establishing resonance by additional springs, of different design, that are dedicated primarily to providing axial force alone. Applications for the electric motor/generator include, but are not limited to, a linear driver for pumps, compressors and linear loads, including linear tools such as saws, mowers, grinders, knives, planers, chisels, needle guns and bits. When combined with a linear engine, the resulting system has applications in domestic, distributed, military, emergency and portable electric power generation, backup for sustainable power generation facilities, and auxiliary power generation for hybrid electric vehicles by virtue of the generating ability of the linear motor/generator. When combined with a linear engine, the resulting system may be started or modulated by the linear motor/generator.

Integrated system solutions can employ high speed resonance with all components designed specifically to employ and contribute to that resonance to achieve attractive power density and high energy conversion efficiency. For example, the springs can be designed to produce high frequency motion of the translator mass and to dominate the system dynamics and assure similar cycle-to-cycle motion. In this case the springs play a major role in defining the motion of the translator and assure that the motion remains substantially similar between two consecutive cycles, despite a change in the in the energy removed or delivered to the oscillating system. With appropriate spring design or selection, the energy sored in the oscillating system during established operation may be far greater than the energy that is added or removed in any single cycle, where the term established refers to operation not associated with a starting or motion initiation period.

For an engine that can be combined with the generator, the combustion timing can be managed to contribute to the system resonance, yet also to take advantage of the cycle-to-cycle repeatability, thereby providing appropriate heat release to meet efficiency and emissions control needs. The engine, whether two-stroke or four stroke, can be designed with resonant exhaust and intake systems to provide superior scavenging or volumetric efficiency while minimizing pumping losses associated with gas exchange. Appropriate exhaust and intake design establishes exhaust and intake resonant frequencies that work in synergy with the frequency of intake events and exhaust events to increase power density. Although resonant generators employing a variety of electromagnetic architectures may be employed, a permanent magnet alternator is preferred to provide electric generation, and can be optimized by design for high performance at the resonant frequency of the system.

In some implementations, the motor/generator is capable of starting the engine through motoring with at least one linear thrust, and switching to generator mode once the engine is running. A linear thrust may be a single motion or there may be a plurality of consecutive thrusts to build resonance energy in the springs and to increase the stroke of the translator and of the piston progressively until combustion can be initiated in the engine.

The operation-process can start with the resonant electric machine operating as a linear oscillatory motor. For example, the motor can run on battery through a power electronics converter (e.g., inverter). The inverter frequency can be increased to reach the resonant frequency of the machine. A phase lock loop (PLL) that locks the phase of position with the inverter frequency can be used to automatically find the system resonant frequency. At the same time the inverter voltage can also be increased. As the frequency and voltage increase the displacement increases, therefore, compression ratio (CR) in the cylinder increases. Once the displacement reaches CR appropriate for combustion, air/fuel mixture can be injected into the cylinder with appropriate timing to ignite the mixture so that combustion occurs. As the system oscillates by combustion in the cylinder, electric output power can be increased. As the electric output power is increased, the air/fuel mixture can be increased, either through a look-up table or through a control algorithm based upon, e.g., mathematical equations.

System resonance denotes the frequency at which the engine and the generator, linked by a common shaft, oscillate. Practically, for high frequency operation, high restoring forces sustain the high frequency of the mass of the generator/alternator. The restoring force is provided primarily by springs, and the energy stored in the springs during each cycle can be substantially greater than the energy delivered by the engine to the alternator in each cycle. Primarily the translating mass and the springs determine the operating frequency. The frequency of the system during steady operation will vary little in response to an anomalous event, such as a misfire of the engine, or a transient load that might otherwise stall the system if it were not designed with springs to sustain resonance. To satisfy resonance, considerations can include: (i) the system dynamics being at the resonant frequency; (ii) the engine providing design power output at the resonant frequency; (iii) the resonant frequency favoring a high engine output or efficiency; and/or (iv) the alternator operating with high efficiency at the resonant frequency.

Examples of both the stand-alone motor/generator and the motor/generator integrated with an engine have been modeled, designed, constructed and physically operated. In the embodiments that have been physically operated the motor/generator is an alternator comprising permanent magnets on the translator and electrical stator coils located on a frame for the system. In these embodiments, flexure springs are integrated to produce high speed resonant operation, allowing either provision of linear motive force as a motor, or receipt of linear thrust to produce electric power as a generator. In one example of a demonstrated system, a 2 stroke engine that includes resonant scavenging via a tuned exhaust system provides the thrust and power delivery to the resonating translator. In this example, the engine, powered by natural gas, is integrated with the alternator to yield a resonant electric generation system. The alternator draws power from the resonating translator. However, the system operation is centered on the resonance and is not limited to the use of a specific fuel, generator design, engine design or spring technology.

Flexure springs have been designed, produced and tested with the linear alternator. It is recognized that the resonant frequency for the flexure springs may be different for the motor/generator operating alone and for the combined engine and generator. This is due to the difference between the translating mass in the two cases. Further refinement to the components as a combination can raise the performance. Discussion of the design is presented below, followed by a description of the physical systems and data obtained during evaluation of those systems.

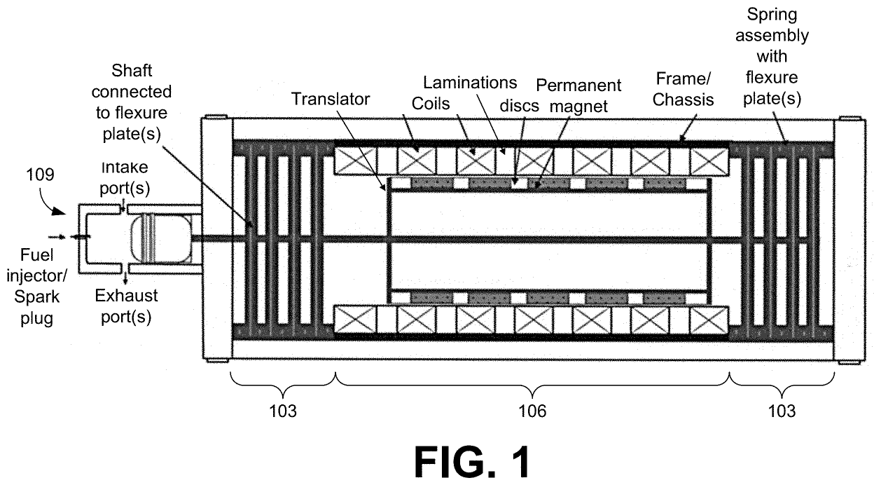

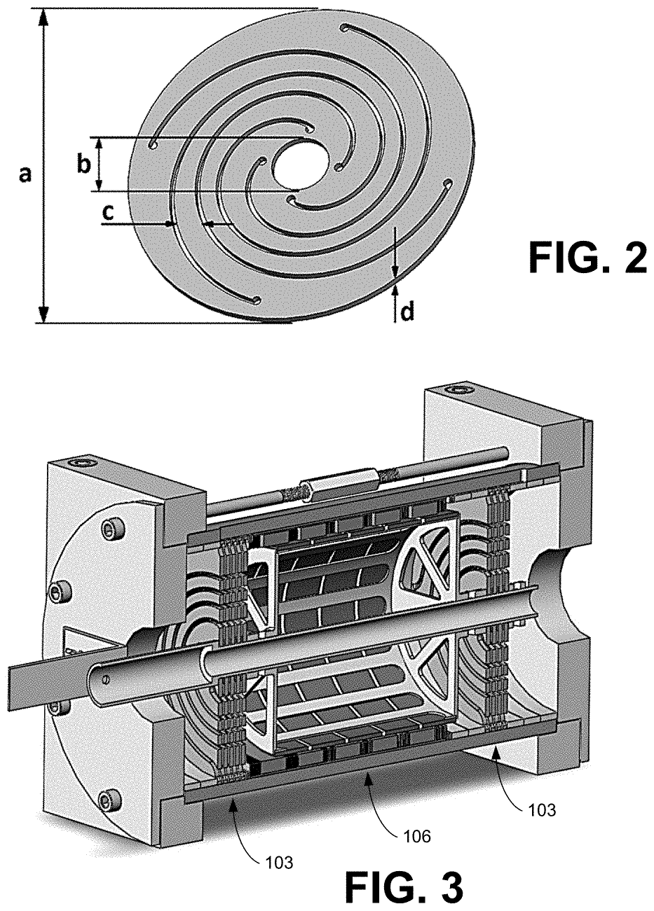

Referring to FIG. 1, shown is a cross-sectional view of an example of a linear resonant machine including an engine with a single piston coupled to an alternator by a rod to form a translator assembly. The resonant system comprises subsystems, each of which can be designed to operate with high efficiency and excellent performance at the chosen resonant frequency. Design of each subsystem included detailed engineering analysis employing engineering theory and practice, using sophisticated modeling tools and experimental optimization. The major physical sub-systems comprise spring assemblies 103 (e.g., one or more high frequency flexure plates that act as both springs and bearings), an electrical generator 106 (e.g., a permanent magnet alternator), and for the case where the generator and an engine are designed and integrated together, an engine 109 (e.g., a two-stroke tuned spark-ignited engine). Other components, such as the fuel injection hardware and controls and the controls that operate the generator as a motor for, e.g., starting can also be designed for operation at the resonant frequency.

Spring Assembly

In the example the spring assembly can utilize one or more flexure springs to constrain radial motion of the translator of the alternator while allowing axial motion. Although flexure springs are emphasized, the resonant operation can be achieved with any spring type, including mechanical and air springs. When springs that do not constrain radial motion are employed in a design, they can be used in conjunction with either flexure springs or linear bearings to constrain radial motion. The flexure springs support a design with compact packaging. A variety of flexure spring designs may be employed, but the flexure springs employed in the operating example comprise circular plates cut with contoured slots such that the center of the plate can move axially relative to the rim of the plate. The force that the flexure springs impart is due to deflection of the material from which they are built, although they do suffer some losses from moving the air around them as they flex, unless operated in an evacuated space. The rim can be attached to a chassis (e.g., frame, housing, or other appropriate support structure), termed the stator assembly, with the flexure center attached to the translator structure carrying the alternator magnets and the engine piston, in the case of an engine/alternator design. The metal between the contoured slots of the flexures represents a set of cantilever springs, constrained in position and slope at the center and at the rim. Other designs of flexure springs that permit axial motion while constraining radial motion comprise circular annuli, with the outer edge attached to the chassis or stator assembly and inner edge connected to the translator. Yet another flexure spring design may comprise leaf springs, attached at each end to the stator assembly, and in the center to the translator, and arranged in alternating orientations so as to constrain motion orthogonal to the translator axial motion. Yet another flexure spring design may comprise a plurality of springs each comprising an outer rim and an inner rim, connected by strands or wires or spokes emanating radially from the center to the rim, and with the center connected to the translator and the rim to the stator assembly. The flexure springs can be designed to satisfy desired resonant characteristics at a desired stroke for the alternator and engine. Materials such as, e.g., titanium alloys or specialty steels can be selected for the flexure springs to avoid fatigue failure. For the type of flexure spring used in the operating example, the geometry of the slots in the plate can be established using computer aided design and analysis to determine the stresses in the flexure plate as a function of overall axial movement. For instance, ANSYS is one tool that can be used for this purpose. These stresses in turn can then be compared with known or tested material properties to insure that the flexure springs will have a substantially infinite life (or an acceptably long design life) during their resonant operation. Design variables for a given material can include, but are not limited to, the number of cantilever arms, inner flexure diameter, outer flexure diameter, and thickness of the flexure plate, and the freedom to define the shape of the slots, and hence the cantilevers.

Further, dynamic analysis can reveal the axial displacement of the plate across its whole surface, which defines the motion of the cantilevers during operation. Research has shown that high frequency modes are usually present, causing stresses that would be higher than in a slow elastic deformation. Consideration of these vibrational modes can assist in determining the resonant frequency and in determining the real world stresses and energy losses that the flexure material will see, and thus will influence the spring durability.

The resonant frequency of the translator assembly relative to the stator assembly is influenced by the force of the flexure spring or springs, and by the force of any additional springs contributing to axial thrust, and by the effective mass of the spring assembly plus the translator mass. The effective mass of the springs is not their total mass because not all parts of the spring move in the same way as the translator. The desired, or target, resonant frequency of the combination may be obtained by having one or a few flexure springs with an individual resonant frequency substantially in excess of the desired system resonant frequency, or by employing a larger number of flexure springs with a resonant frequency that exceeds the desired resonant frequency by a lesser amount. Given the translator mass and a chosen number of flexure springs, an individual flexure spring design can be executed to yield the necessary spring force to achieve the desired results, while adding effective mass to the total reciprocating mass.

The flexure plates additionally serve to constrain the center axis of the translator, and thus act as linear bearings as well as axial springs. In this way, the flexure bearings oppose any radial forces that may arise due to gravity, electromagnetic attraction, pressure imbalances or mechanical imbalances and obviate the need for all or some dedicated linear bearings to constrain the translator assembly within the stator assembly. Typically, these radial forces are small relative to the axial resonant spring forces, and need not be considered in the flexure spring design.

Flexure springs can be designed with the assumption that the translator that they support is a solid, rigid mass, so that the axial distribution of mass in the translator may be neglected in the individual flexure design. However, while the translator rigidity or flexibility can be ignored in the design of the flexure springs, it may be addressed elsewhere in the design process.

The stator assembly may be mounted to a base rigidly or may be mounted in a way that permits motion relative to the base or may be suspended from a member in various ways, so that both the stator and translator assemblies may move in a cyclic fashion relative to their immediate environment or relative to the base. It is the relative resonant motion between the stator and translator assemblies that is considered for the operation of the generator/motor or the engine/generator.

While flexure springs are diverse in design and while many techniques may be used to create flexure springs, including fabrication from component parts or the creation of a composite piece, a favored approach involves machining or cutting a metal plate to produce the spring. Mechanical, fluid or fluid-abrasive cutting may be employed. The plate can be slit in a way that produces a number of members joining the outer edge of the plate to the center of the plate. These members typically follow a spiral path, allowing them to be longer than the radius of the plate. The spiral slits can extend inward between adjacent slits to form spiral members secured between the inner (or center) and outer edges of the flexure spring.

Typically, during spring deformation, each member is constrained in the plane of the plate at the outer edge, and by the parallel plane of the center. In this way, each end of each member at the constrained ends acts as a cantilever, and spring action is provided by the bending of the members. Deflection also introduces some torsion and this torsion resists the axial motion and provides further spring force. The members typically have the same thickness as the plate, so that primary variables considered in the design of a flexure spring include the plate thickness and diameter, number of members per plate, width of members, and length of members, where the length is determined by the spiral path from center to outer section.

The design of a flexure spring can proceed in the following fashion. First, the target resonant frequency and the translating alternator mass (excluding springs) are identified. Next, the spring count can be determined as a function of the spring resonant frequency. This may yield several options, ranging from many flexure springs each having an independent resonant frequency slightly higher than the system target frequency, to as few as two flexure springs (or one flexure spring and a bearing), where the flexure spring resonant frequency is higher. One of these options may suit best an objective such as cost minimization or system size minimization or the possible incorporation of additional springs of different design to facilitate resonant behavior.

There is an upper limit to the independent resonant frequency of a flexure spring under the constraints of the target stroke and the desired resonant frequency, and that limit depends on the material used. Titanium and specialty stainless steels are very attractive options, however other suitable materials may also be employed. Both of these materials have been employed in implementations of the linear resonant machines.

Moving Mass.

The spring can be designed to minimize the moving mass, provided that, when coupled to the linear engine and alternator (LEA), the desired frequency is realized. For a dynamic system, the magnitude of the moving mass affects the system response significantly. The acceleration and velocity of the moving parts, reaction force at fixtures, and the natural frequency of the system are parameters which are a function of the effective mass of the system.

The design for resonance considers the mass of the springs, but the outer edge of the flexure is fixed to the stator assembly and only the innermost part moves at the velocity of the translator. Modeling can be used to establish the effective mass of the flexure and its influence of system dynamics.

Referring to FIG. 3, shown is a cross-sectional perspective view of an example of a high frequency resonant linear machine including spring assemblies 103 having a set of flexure springs designed for resonant operation as discussed above, and an electrical generator 106 (e.g. an alternator) with an electrical stator winding and a permanent magnet translator supported by the spring assemblies 103. As can be seen in FIG. 3, the permanent magnets of the translator are supported by a frame mounted on the shaft. The frame can be open to reduce wind resistance when oscillating. The alternator can employ an air core, or can include an iron core to enhance the magnetic characteristics. The iron core adds mass to the LEA. The mass of the translator can be adjusted by including additional supports and/or plates. The permanent magnets of the translator are surrounded by the coils of the electrical stator winding, which are supported by a structure that is rigid with the chassis, or stator assembly. While not illustrated in FIG. 3, one or more piston(s) of engine(s) 109 can be coupled to the shaft for driving the generator 106. The piston(s) run in one or more engine cylinder(s) that are attached rigidly to the chassis or stator assembly. In addition to the flexure springs, resonant operation of the system is also influenced by the design of the generator and the engine. The resonant operation can preserve operation through stumble, engine misfire, or brief loss of electrical supply or load connection.

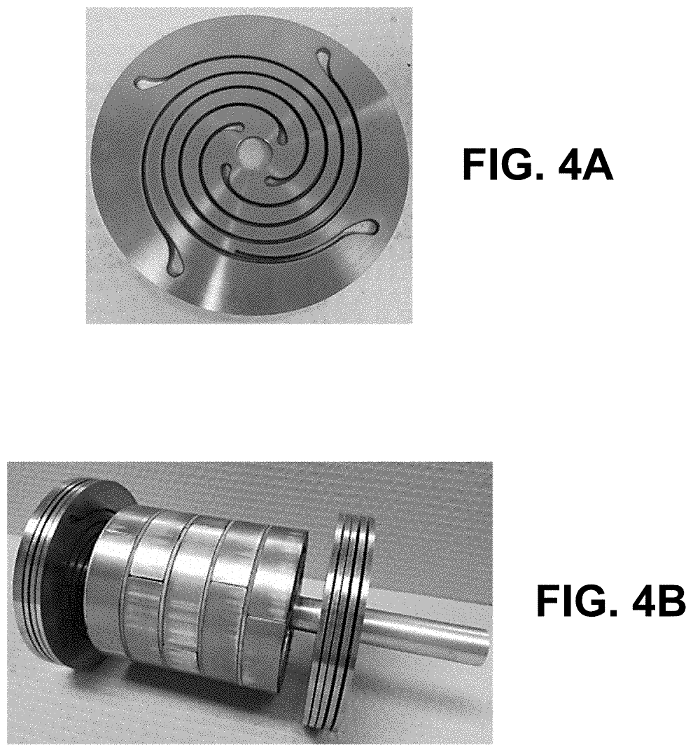

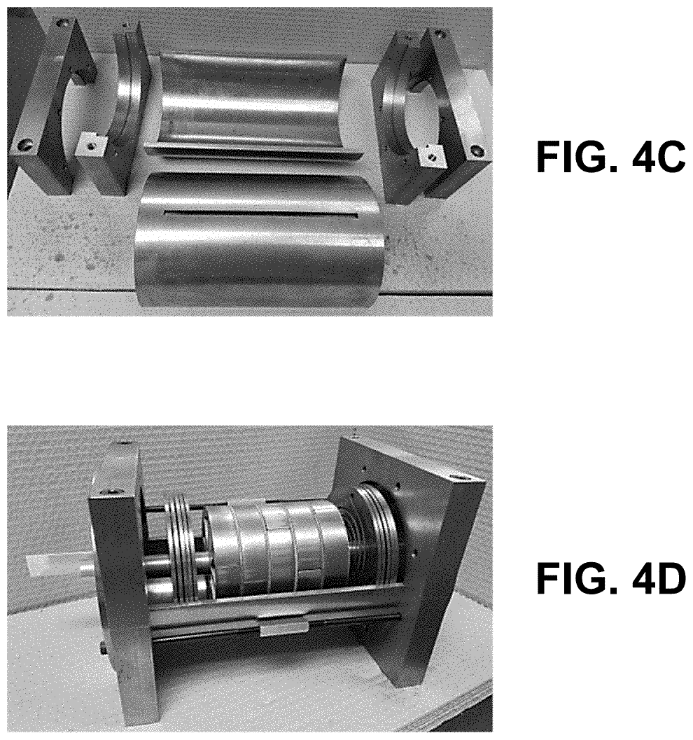

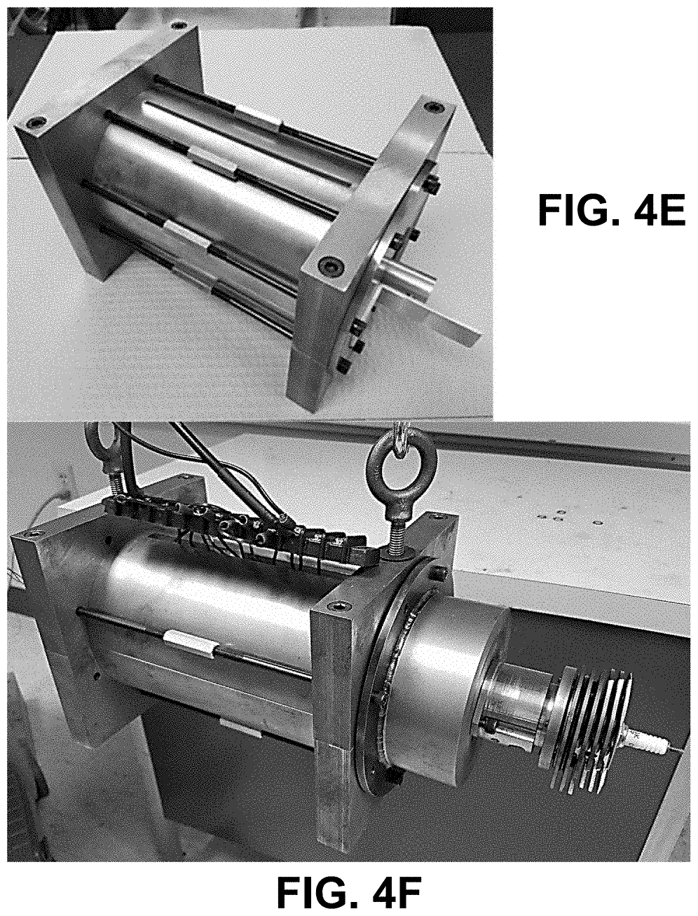

A resonant linear machine was fabricated based on the general design illustrated in FIG. 3 for testing and evaluation of the system. FIGS. 4A-4F are images showing components and the assembled resonant linear machine. FIG. 4A shows a side view of a flexure spring design including stress relief shapes at the ends of the slits. FIG. 4B shows the assembled translator with the shaft supported on both sides by spring assemblies including five flexure springs. FIGS. 4C, 4D and 4E show the disassembled frame components, the translator and spring assemblies positioned in the frame and the assembled linear alternator, respectively. A single engine piston was installed on the shaft of the translator as shown in the image of FIG. 4F. The piston translated in an engine cylinder that was rigidly attached to the chassis or stator assembly. The fabricated linear alternator had a moving mass of 820 grams, a displacement of less than 2.7 cm, and a resonant frequency in the range of about 70 Hz to about 93 Hz.

Engine.

Most engines that employ intake or exhaust tuning for high performance in a power band are also designed to operate for sustained periods at various speeds and loads. In the resonant LEA, the engine is capable of reaching the resonant point, but all of the optimization is geared to performance at a narrow selected range of speeds, or for greater added value, a single speed and single load. Control optimizations can manage the fuel injection and spark timing, but the greatest effort is to manage the scavenging of the working gases when a two stroke design is used, as in the embodiment presented here. This can be accomplished by appropriate placement of scavenging ports, with their locations defined on the circumference, and with their opening and closing positions as a fraction of the stroke, and with their size and shape defined. More importantly, to enhance the resonant performance of the engine at a fixed speed and load, the intake and exhaust systems can be designed to take advantage of the compressive nature of gases, and to reflect pressure (or vacuum) waves that enhance the scavenging process. Properly designed intake and exhaust systems will raise the volumetric efficiency of the scavenging process and insure that the concentration of burned gases in the cylinder is reduced in the next combustion cycle. Optimization of these systems can utilize a detailed resonant design that is also dependent on the behavior of the engine itself. Design may employ compressible flow theory and the use of inertial effects, followed by empirical adjustment, or one dimensional or three dimensional code to model the flow. AVL BOOST™ is one tool that can be employed. Designs usually include specified lengths of pipe coupled with volumes that have converging and diverging sections at each end. Even with computer based modeling, the design is typically altered empirically to find the highest scavenging performance.

The engine used was a two-stroke type, and scavenging performance is far more dependent on engine speed than it is for a four-stroke, positive displacement engine that alternatively may be employed. The engine design was implemented to purge the exhaust gas from the cylinder via an exhaust port or ports, and replace the exhaust gas with either air (if fuel is directly injected into the cylinder) or a fuel/air mixture (if fuel is added upstream of the engine cylinder) through the intake port or ports (see FIG. 1). Although the piston motion differs slightly from the piston motion in a conventional crank-type engine, the art for conventional engines may be employed as an initial design tool for the port design and placement, intake, exhaust and controls. Equivalency between crank angle, which is normally used as a reference in traditional engine design, and either time or position can allow traditional correlations to be employed for LEA design. While reduction to practice has been with a two-stroke engine, the resonant system does not exclude four stroke technology noting that the energy stored in the springs by design is sufficient to carry the engine through all four strokes where only one of the four yields substantial energy input to the system.

Friction plays a role in reducing the efficiency of the engine and hence the LEA. The friction differs from the friction in a conventional slider crank engine because the piston sees no side-thrust from the connecting rod and hence substantially reduced friction between the piston and cylinder wall. The piston also describes a different motion in the LEA than in a slider-crank engine, leading to different interactions of the piston ring or rings with the oil film on the cylinder wall and with the cylinder wall itself. One consideration in the design is the decision on the count of rings, where a higher number of rings can reduce mass loss from the cylinder to increase overall efficiency, while increasing frictional interaction with the wall, reducing efficiency. An example of the decisions related to the use of one or two rings is presented “Piston Ring Friction Comparison in a Free Piston and Conventional Crankshaft Engines” by M. Bade, N. Clark, T. Musho, and P. Famouri. (ASME 2018 Internal Combustion Engine Division Fall Technical Conference, Paper ICEF2018-9774, 2018), which is hereby incorporated by reference in its entirety.

The engine in the LEA can be operated in both a port injected mode, and a direct injected mode. The direct injection reduces the loss of unburned fuel gas to the exhaust during the scavenging process. Ignition is via a spark plug and high voltage ignition system. When integrated with the alternator, a linear position sensor may provide information on the stroke. This may be used to trigger injection and spark timing. The injection quantity, start of injection, and spark timing can be changed manually using an electronic interface. In a final product, optimum timing of the spark, timing of the injection and injection quantity would be determined, and the controls would be embedded into an engine or system electronic control unit that would manage the injection and spark.

The tuning of intake and exhaust systems has been examined previously. It may be desirable to design an intake system such that the prior intake event causes a pressure wave to arrive at the intake during the following event, assisting in forcing intake gas into the cylinder. The linear engine may operate without crankcase compression, once started, if the intake and exhaust are both resonant and directly attached to the intake and exhaust ports respectively. However, the linear engine employed for testing has used crankcase compression. In this case intake resonance assists with charging the crankcase and providing a greater crankcase pressure to scavenge the cylinder.

With an exhaust system, a rarefaction wave (suction) can be induced by the prior exhaust event, and can arrive at the port in time to assist the withdrawal of gases from the exhaust port. It may also be beneficial to prevent further flow (using exhaust pressure) from the exhaust port once the fuel-air mixture has been introduced into the cylinder. In conventional engines that operate over a range of speeds, a resonant intake or exhaust system promotes high power over a limited band of engine operating speeds, and may detract from power at other speeds. In the case of the resonant linear engine, designed to operate substantially at a specific frequency, the intake and exhaust conduits should be designed to deliver the pressure and rarefaction waves specifically to suit a narrow range of frequency of operation. Details of the exhaust resonator design for a LEA is given in “Quantification of Energy Pathways and Gas Exchange of a Small Port Injection SI Two-Stroke Natural Gas Engine Operating on Different Exhaust Configurations” by Mandi Darzi, Derek Johnson, Christopher Ulishney, Ramanjaneya Mehar Bade, Nima Zamani Meymian, Gregory Thompson, Nigel Clark and Parviz Famouri (SAE Technical Paper 2018-01-1278, 2018, doi:10.4271/2018-01-1278), which is hereby incorporated by reference in its entirety.

The Darzi et al. paper presents two designs that may be employed. One has a length of exhaust tube, followed by a divergent cone, followed by a convergent cone, followed by a length of tube that is the tailpipe. The other has a length of exhaust tube, followed by a divergent cone, followed by a cylindrical pipe section, followed by a convergent cone, followed by a length of tube that is the tailpipe. Precise dimensions of these geometries are given in the paper. The paper presents experimental data showing the benefit of the second design over the first. Generally, the design can be optimized with empirical methods (modifying geometries) because the intake, scavenging and exhaust processes are complex and meshed with one another.

Alternator.

The alternator can also be designed to operate successfully at the resonant frequency. For high frequency operation, is it beneficial for the translator, which incorporates the moving part of the alternator, to be as light as possible. Finite element techniques can be used to comparatively and iteratively determine best materials with respect to mass, durability and electromagnetic properties, and to determine the best design configuration. One aspect is the identification of the permanent magnet material and geometry that can be utilized to produce the target electrical energy output and to match the engine energy input. The effect of stator-translator clearances will also be considered, since these can assure that the moving components do not come into contact, yet some components may be located closely during the stroke to facilitate high efficiency electric generation.

System Integration.

Although each component can be designed to operate optimally at the same design frequency, there is also sophisticated technical design effort associated with integration of the various components. This falls into two categories. The first, related to the mechanical design, includes the specification of the translator rod and the stator assembly (chassis or frame) that carries the stator components such as the engine cylinder and electrical stator windings. The tradeoff that occurs for the moving components is between mass and rigidity. An increased mass reduces frequency and hence power density, all else being equal, while lack of rigidity can lead to rubbing losses between components that would not be anticipated in a rigid body analysis.

The second category of integration relates to overall system modeling, which is computer-based, and where combustion, spring, electrical and frictional forces can be combined in a dynamic equation to define the translator motion for the engine/generator case, and where the load or mechanical power source and motor/generator can be integrated when the stand alone motor/generator concept is employed with other components. This motion is typically not sinusoidal or similar to that of a slider-crank engine, and may differ slightly from the anticipated motion that was used in component design. A Matlab/Simulink model, as an example, can be used to assess the motion. Aspects of such a model can be found in “Sensitivity Analysis and Control Methodology for Linear Engine Alternator” by M. Bade, N. Clark, P. Famouri, P. Guggilapu, M. Darzi and D. Johnson (SAE Technical Paper, No. 2019-01-0230, 2019), which is hereby incorporated by reference in its entirety. This model can incorporate sub-models for the engine and alternator, so that electrical forces, friction, combustion and engine heat loss can all be incorporated. The resulting motion is critical to the engine port and ignition timing, and is essential for devising the control strategy for the engine. The overall control strategy addresses engine and alternator control parameters, but also manages the cycle-to-cycle behavior, such that there is not an accumulation of or a decline in energy stored in the linear system, such as in the springs. In other words, integration modeling can be used to assure that a real world engine and alternator remain matched in power output delivered and power input supplied, respectively. Such matching would insure that the stroke remained substantially constant from cycle to cycle. Typically the control strategy can be based on translator position and/or translator velocity at chosen points in the cycle.

Starting the Engine/Alternator in a Combined System.

Many methods may be used to start the system, including independent linear motors. In the example LEA that has been fabricated and operated, starting is enabled using the alternator as a motor in this following way. The linear alternator is coupled to an electric machine designed primarily as an alternator. The linear resonant machine employs permanent magnets on the translator and coils or windings attached to the stator assembly. Starting of the linear resonant machine employs the system resonance, and delivers electric current to the electrical stator coils to initiate movement of the translator assembly at the anticipated system resonant frequency. With successive cycles, more energy can be introduced into the resonant system and the oscillating amplitude (stroke) can grow as the cumulative energy grows. This energy is stored variously in the springs and as kinetic energy of the translator mass over different portions of the stroke. Some of the added energy is lost irreversibly in each cycle (friction, wind loss, etc.), but there is a net gain in energy until a stroke length sufficient to scavenge the engine, ignite the mixture and run the engine is achieved. An H bridge inverter circuit is one example of an electrical means that can be used to deliver pulses of current to the coils, resulting in pulses of force that add energy to the oscillating system. These pulses could be delivered in both directions of motion, but only need to be delivered in one direction for starting the LEA. In that case, the spring stores energy in the first direction and reverses the direction of the translator for alternate strokes. A linear magnetic encoder can be used to determine the translator position and a digital signal processor can be used to design a phase locked loop (PLL) system so that the pulses are given at the correct resonant frequency. The translator oscillates and as one example the detected point of zero velocity provides the trigger for the power input. In this way, starting of the linear resonant machine may be synchronized with the actual system resonance in closed loop rather than by employing an assumed or calculated system frequency. This yields a faster rise in amplitude and a greater amplitude after a number of cycles for starting the engine.

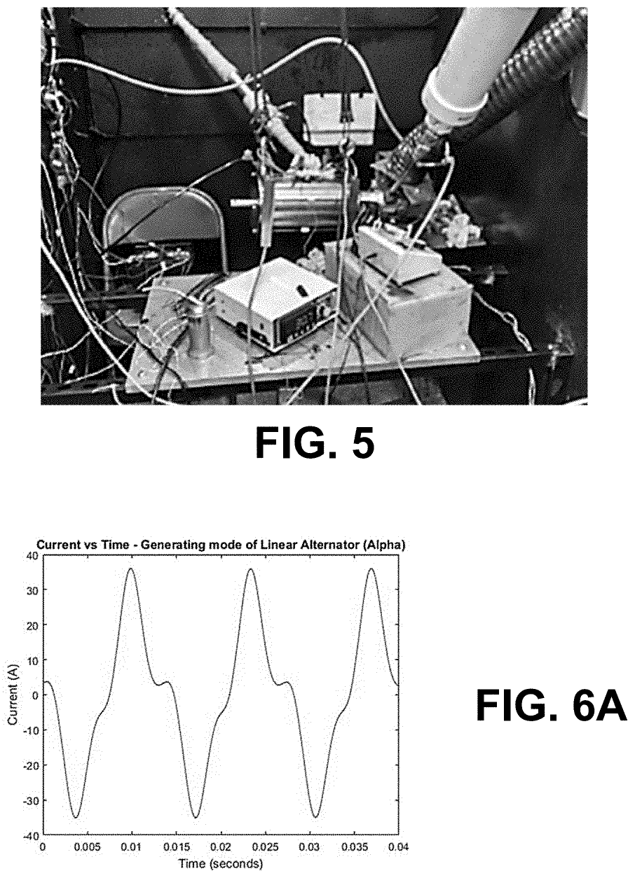

The combined LEA system was evaluated through testing. FIG. 5 is an image of the setup used for testing the alternator with integrated engine. The alternator and engine were designed for an improved efficiency at a selected resonant frequency. The flexure springs within the alternator housing were designed to match the resonant frequency, based on the reciprocating mass. This testing verified the use of the alternator as a generator to convert energy from the engine. The setup also confirmed the starting method describe above.

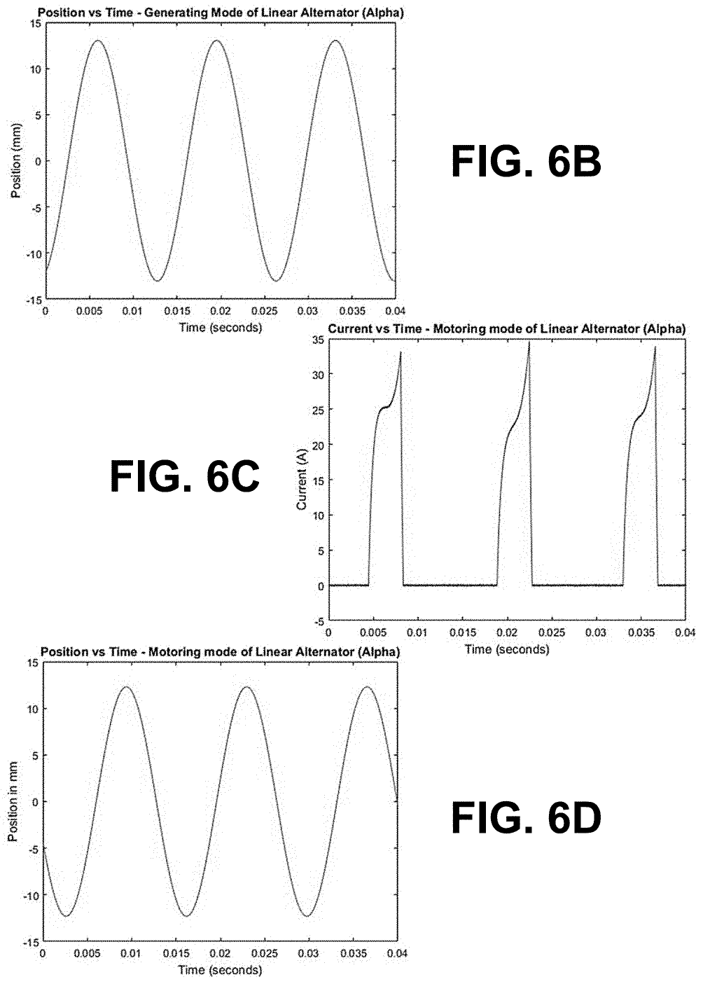

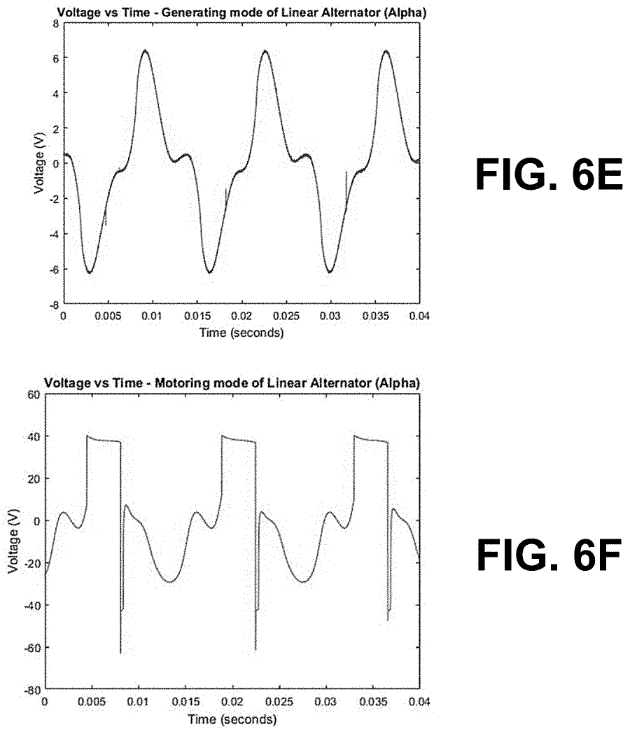

During operational testing current, voltage and movement of the linear resonant machine was monitored in recorded. FIG. 6A is a plot illustrating the current from the alternator when it is fed power by linear motion from the linear engine with which it is integrated. The current demonstrates that the high frequency resonance provides power with a repeatable waveform. FIG. 6B is a plot of the motion of translator rod joining the linear alternator, engine piston and center of flexure springs. The smooth substantially sinusoidal curve shows the frequency of resonant motion, which produces the current from the alternator shown in FIG. 6A.

FIG. 6C is a plot illustrating the current supplied to the alternator when it is fed power to operate as a motor. In response to the current received by the linear alternator, the motor produces cyclic linear motion at the translator rod. FIG. 6D is a plot of the motion of translator rod with the electrical machine acting as a motor, coupled to flexure springs, and producing resonant motion in response to the driving current. FIG. 6E shows the voltage generated by the alternator when operated as a generator, and FIG. 6F shows the voltage applied to the alternator when operated as a motor.

Described here is the linear engine/generator comprising a stator assembly (frame or chassis) and a translator assembly. In some implementations, the frame can be fixed to a large reference mass and the translator allowed to move, or the frame and translator can both move relative to their environment, typically in opposite directions at most moments in time. The translator is located on an axis through the frame and comprises a rod or shaft with a piston attached at one or both ends. For the two-cylinder case, the pistons run in cylinders that are attached to the frame at opposite ends. The translator carries permanent magnets in the center section between the pistons, and the oscillating translator and magnets induce voltage and current in the coils of the generator, mounted to the frame.

The translator is constrained to move axially through attachment to the frame via flexure springs, which act both as high frequency resonant springs and linear bearings. The engine design can include a stroke matched to the flexure spring constant and oscillating mass of the whole translator. The remaining components are auxiliary to the engine, and can comprise scavenging ports in the cylinders, provision for crankcase scavenging beneath the piston, a fuel supply, a fuel injection system and an ignition system where a spark is used to initiate combustion. These components are designed to support the resonance at a high frequency, with engine induction and exhaust flow assisted using resonant pipes. The alternator and springs may be integrated with the engine to yield a resonant linear motion generator or motor with broad applications in energy transfer. Examples include the use of the resonant linear motor to drive a pump or compressor or reciprocating device such as a shaper, saw, file, descaler, or impact device. Further examples include the generator driven by sources such as compressed gas, hydraulic fluid, a heat engine, a Stirling engine, or wave motion. In all of these cases the resonant frequency of the motor/generator can be matched to an appropriate frequency of the energy source or sink to which it is coupled.

Substantially more energy can be stored in a resonating system comprising the linear resonant machine than is transmitted from at least one source to at least one sink through axial force during a single stroke of the translator, where the at least one source and the at least one sink each are connected at least to the translator. The energy stored in the resonating system can be at least ten times the energy transmitted during a single stroke of the translator. The energy stored in the resonating system can cause motion of the translator for one cycle of the linear resonant machine to be substantially similar to motion of the translator from a prior or preceding cycle. The energy stored in the resonating system can be sufficient to ensure that displacement of a current translator stroke is substantially similar to displacement of a prior or preceding translator stroke even if the quantity of energy that is transmitted to or from the translator on the current stroke is substantially different from the energy that is transmitted to or from the translator on the prior or preceding stroke.

A robust methodology for flexural spring design with both high stroke and high frequency applications has been presented. Amongst a large number of contributing parameters in flexure design, main parameters were identified and included at least outer diameter, thickness, and the number of arms.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.7%, and 4.4%) within the indicated range. The term “about” can include traditional rounding according to significant figures of numerical values. In addition, the phrase “about ‘x’ to ‘y’” includes “about ‘x’ to about y”.

1. A linear resonant electrical machine, comprising:
an electrical stator comprising at least one winding;
a translator disposed within the at least one winding of the electrical stator and carrying at least one permanent magnet, the translator centrally supported within a stator assembly, and
one or more springs providing axial coupling force between the translator and a chassis or the stator assembly, where each of the one or more springs comprises a flexure plate coupled between the translator and the chassis or stator assembly of the linear resonant machine, and the one or more springs are configured to oscillate the translator axially at a resonant frequency within the at least one winding of the electrical stator.

2. The linear resonant machine of claim 1, wherein the flexure plate is disposed at a substantially right angle to a system axis of motion and attached at an inner edge to the translator and at the outer edge to the chassis or stator assembly and provides axial thrust in reaction to axial displacement and support to hold the translator centrally within the stator assembly.

3. The linear resonant machine of claim 1, wherein the one or more springs comprise one or more flexure plates comprising spiral slits extending between an inner edge of the one or more flexure plates and an outer edge of the one or more flexure plates and wherein the one or more flexure plates holds the translator centrally within the stator assembly, and wherein ends of the spiral slits are shaped to reduce stress in the one or more flexure plates during operation at the resonant frequency.

4. The linear resonant machine of claim 3, wherein the one or more springs comprise at least two separate flexure plate designs.

5. The linear resonant machine of claim 3, comprising at least one linear bearing configured to constrain the translator centrally within the stator assembly.

6. The linear resonant machine of claim 3, wherein the outer edge of at least one of the one or more flexure plates is a continuous edge with a first end of each of the spiral slits adjacent to the outer edge.

7. The linear resonant machine of claim 6, wherein the inner edge of the at least one flexure plate is a continuous edge with a second end of each of the spiral slits adjacent to the inner edge.

8. The linear resonant machine of claim 7, wherein the first and second ends of the spiral slits are on substantially opposite sides of a central opening defined by the inner edge of the flexure plate.

9. The linear resonant machine of claim 3, wherein a shaft holds the translator and is coupled to and passes through a central opening defined by the inner edge of the one or more flexure plates, and the outer edge is coupled to the chassis or the stator assembly.

10. The linear resonant machine of claim 3, comprising an engine coupled to a shaft of the translator, wherein the engine comprises at least a cylinder and a piston configured to drive the translator at the resonant frequency to generate electrical power.

11. The linear resonant machine of claim 10, comprising at least one linear bearing utilizing an outer surface of the piston, wherein the piston translates axially within the cylinder of the engine.

12. The linear resonant machine of claim 10, comprising resonant exhaust and intake systems coupled to the engine, the resonant exhaust and intake systems designed to enhance operation of the engine at about the resonant frequency.

13. The linear resonant machine of claim 11, wherein the resonant exhaust and intake systems are used with a two-stroke cycle design and without aid of compression in a chamber beneath the piston.

14. The linear resonant machine of claim 10, comprising a linear position sensor mounted on the chassis of the linear resonant machine, the linear position sensor configured to detect motion of the translator and shaft.

15. The linear resonant machine of claim 14, wherein operation of the engine is controlled based upon the motion of the shaft.

16. The linear resonant machine of claim 10, wherein a two-stroke cycle design is employed, wherein compression in a chamber beneath the piston is employed to aid scavenging and wherein the cylinder incorporates ports for the scavenging of the cylinder volume.

17. The linear resonant machine of claim 10, wherein fuel is added to air to form a combustible mixture by direct injection into the cylinder

18. The linear resonant machine of claim 10, comprising two engines coupled to opposite ends of the shaft of the translator, the two engines configured to drive the translator at the resonant frequency to generate electrical power.

19. The linear resonant machine of claim 1, comprising electronic control circuitry coupled to the at least one winding of the electrical stator, the electronic control circuitry configured to control movement of the translator at the resonant frequency by pulsing the electrical stator winding.

20. The linear resonant machine of claim 19, wherein pulsing of the at least one winding of the electrical stator is controlled based upon sensed position or velocity of a shaft of the translator.

21. The linear resonant machine of claim 19, wherein a stroke of the translator is increased by repeated pulsing of the at least one winding of the electrical stator at about the resonant frequency.

22. The linear resonant machine of claim 1, wherein the translator comprises permanent magnets mounted on a frame supported by a shaft of the translator.

23. The linear resonant machine of claim 22, wherein the at least one winding of the electrical stator comprises an air core.

24. The linear resonant machine of claim 22, wherein the at least one winding of the electrical stator comprises an iron or ferromagnetic material core.

25. The linear resonant machine of claim 1, wherein the translator comprises high reciprocating mass and the one or more springs comprise a high spring constant to provide for high system energy storage.

26. The linear resonant machine of claim 1, wherein the translator comprises low reciprocating mass and the one or more springs comprise a high spring constant to provide for high frequency operation.
